(19) United States
(12) Patent Application Publication
(10) Pub. No.: US 2003/0010575 A1
(43) Pub. Date: Jan. 16, 2003

(54) Emergency moving device of an elevator

(76) Inventor: Yung-Hsin Chen, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,713

(22) Filed: Jul. 11, 2001

(51) Int. Cl. B66B 11/08; B66B 9/02

(52) U.S. Cl. 187/263; 187/255; 187/270

(57) ABSTRACT

An emergency moving device of an elevator includes a main moving gear and a reduction gear, both disposed on the top of the elevator car. Chains are passed under a respective one of several gears connected to shafts of the reduction gear. The chains are connected to a first connector, which is disposed above the car, and is connected to steel ropes of the car. When a breakdown of the elevator causes the car to stop between two of the floors, the passengers can control an emergency power supply to activate. A fall prevention member to free the carriage from the first connector for permitting the carriage to move down relative to the first connector; the emergency power also activates a braking switch of the main gear for same to turn in order to drive the reduction gear and the gears connected to the chains for lowering the car.

### BACKGROUND OF THE INVENTION

The present invention relates to an emergency moving device of an elevator which can help the car member of the elevator to move up or down to a next floor of the building when breakdown or power failure causes the car member to stop between the floors.

Referring to FIG. 8, a conventional elevator has a car member 10, steel ropes 20, a main motor 30 and a balance weight.

The carriage member 10 is received in the longitudinal passage of the building. The steel ropes 20 are connected to a top of the car member 10 from one end, and passed around the main motor 30. The balance weight 40 is connected to the other ends of the steel ropes 30.

Then, the car member 10 can be moved up and down along the longitudinal passage to transport people from one floor to another.

However, the motor 30 will stop running to prevent the car member 10 from falling down in case of power failure or breakdown. Consequently, the car member 10 stops between two adjacent one of the floors, and the passengers can't get off same safety until the breakdown or power failure is handled, i.e. the passengers usually have to wait anxiously in the car member 10 a relatively long time until the breakdown or power failure is fixed.

### SUMMARY OF THE INVENTION

Therefore, it is a main object of the present invention to provide an emergency device to an elevator such that the member of the elevator can be moved to a next floor for the passengers to get off the elevator without delay after the power failure or breakdown.

The emergency moving device of an elevator in the present invention includes a main moving gear, a reduction gear, gears and several chains.

The main moving gear is disposed on a top of a car of the elevator. The reduction gear is fixed on the top of the car, and has shafts connected to the gears for imparting turning movement to the gears on activation of the main moving gear.

The chains are passed under a respective one of the gears, and connected to a bottom of a first connecting member, which is fixedly connected to steel ropes of the elevator, for permitting the gears to turn to make the car move downwards relative to the first connecting member when the passenger in the car member control an emergency power supply for same to activate a fall prevention member to free the car from the first connecting member for permitting the car member to move down relative to the first connecting member, and activate a braking switch of the main moving gear for permitting the main gear to turn in a breakdown of the elevator causing the car member to stop between two adjacent ones of the floors of the building.

A position sensor is provided to make the fall prevention member move to a locking position to stop the member from moving relative to the first connecting member, and make the locking switch stop the main moving gear from turning when the car is moved downwards to a lower one of the adjacent floors in the breakdown of the elevator.

### BRIEF DESCRIPTION OF THE DRAWINGS

This invention will be better understood by referring to the accompanying drawings, wherein:

FIG. 1 is a front view of an elevator having the emergency moving device of the present invention.

FIG. 2 is a side view of the elevator having the emergency moving device of the present invention.

FIG. 3 is a fragmentary front view of the emergency moving device of an elevator according to the present invention.

FIG. 4 is a fragmentary side view of the emergency moving device of an elevator in FIG. 3.

FIG. 5 is a side view of the elevator in FIG. 2 with the car being lowered to a nearest floor in breakdown of the elevator.

FIG. 6 is a fragmentary front view of the emergency moving device of the present invention, working in the emergency.

FIG. 7 is a fragmentary side view of the emergency moving device of the present invention, working in the emergency.

FIG. 8 is a side view of a conventional elevator as described in the Background.

### DETAILED DESCRIPTION OF THE PREFERRED EMBODIMENT

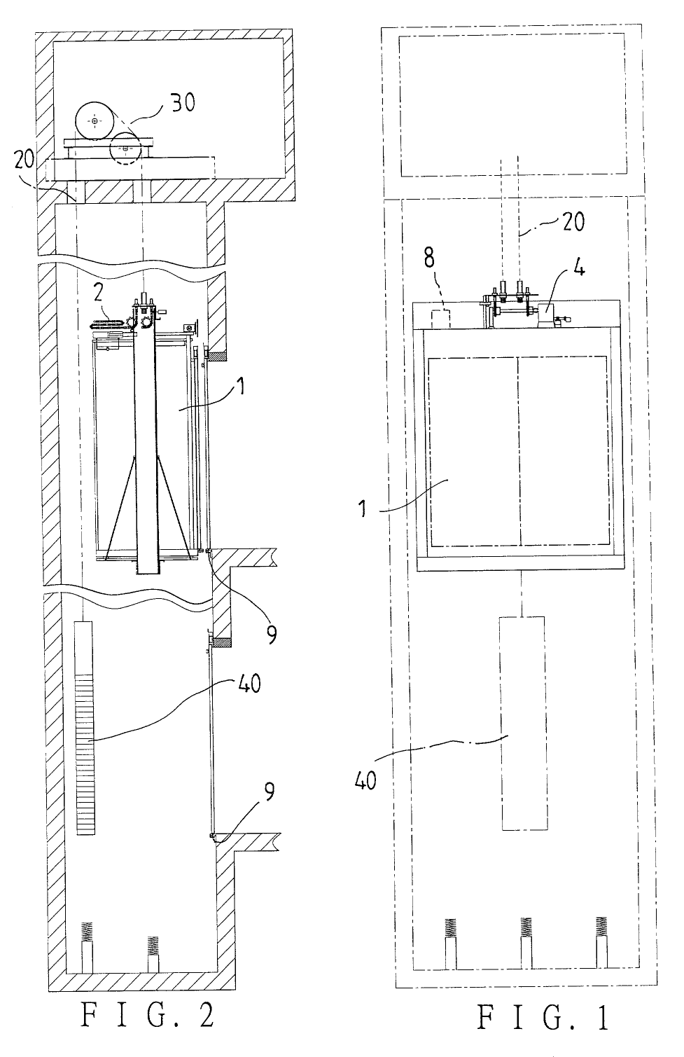

Referring to FIGS. 1, 2, 3 and 4, an elevator is provided with the emergency moving device of the present invention. The elevator includes a member 1, steel ropes 20, a main motor 30 and a balance weight 40. The steel ropes 20 are passed around the main motor 30, and each connected to the balance weight 40 from one end. The member is received in a longitudinal passage of a building.

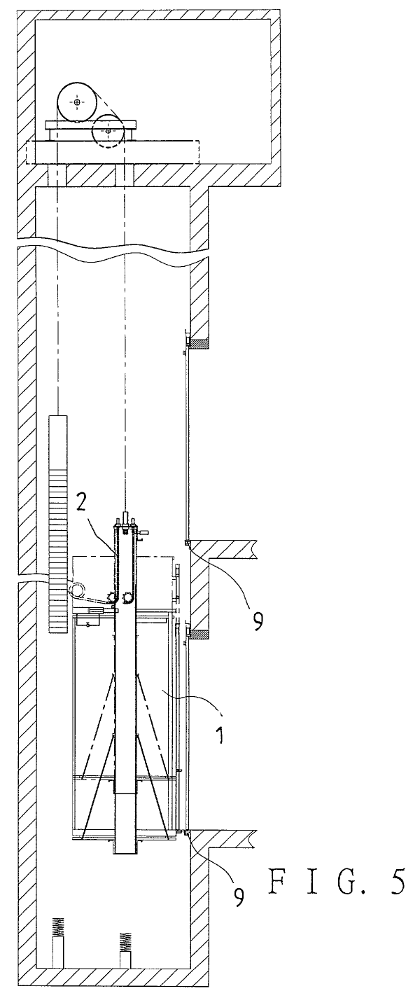

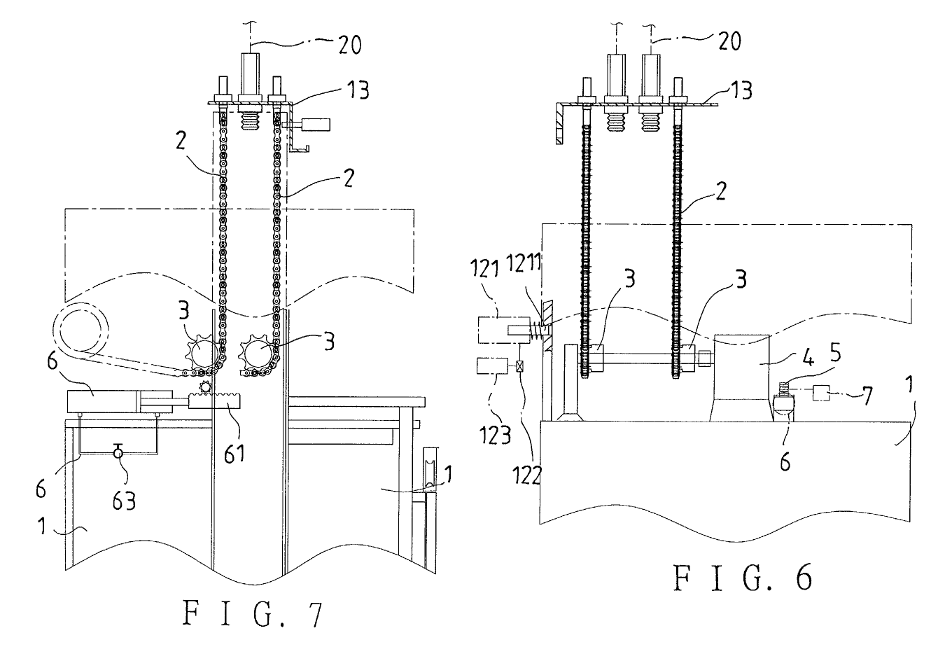

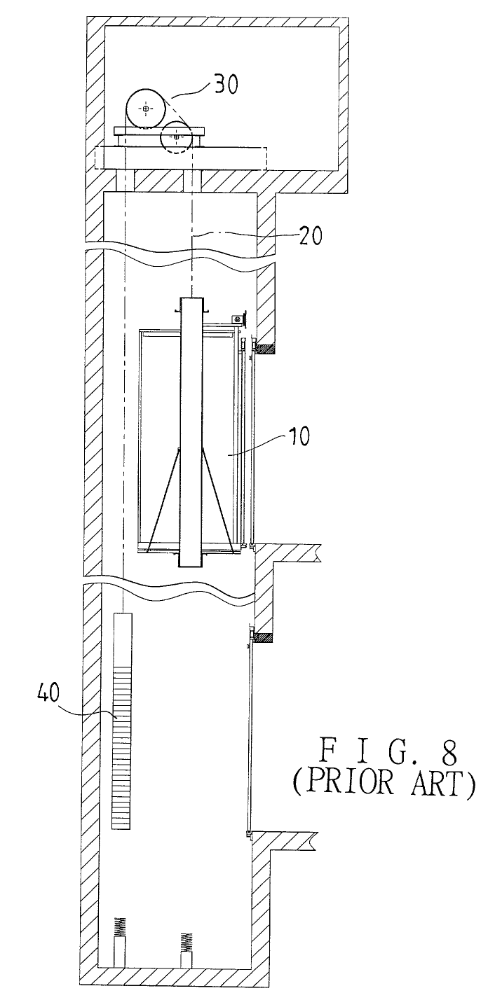

The emergency moving device includes a first connecting member 13, a second connecting member 11, an oil hydraulic cylinder 6, several chains 2, gears 3, a main moving gear 5, a fall prevention device 12, a reduction gear 4, a braking switch 7, an emergency power supply 8 and positioning sensors 9 (FIG. 5).

The first connecting member 13 is movably disposed above the car member 1, and connected to the other ends of the steel ropes 20 from the upper side. The first connecting member 13 is connected to first ends of the chains 2 from the lower side.

The gears 3 are connected to shafts (not numbered) of the reduction gear 4, which is fixedly disposed on the top of the car member 1. The oil hydraulic cylinder 6 is also fixedly disposed on the top of the car member 1, and has oil return pipe 62, a governor valve 63 and a moving toothed bar 61. The moving toothed bar 61 has engaging teeth (not numbered) formed along the upper side, and engages both the main moving gear 5 and a main gear (not shown) of the reduction gear 4. The main moving gear 5 is electrically connected to the braking switch 7. And, the emergency power supply 8 is electrically connected to the braking switch 7.

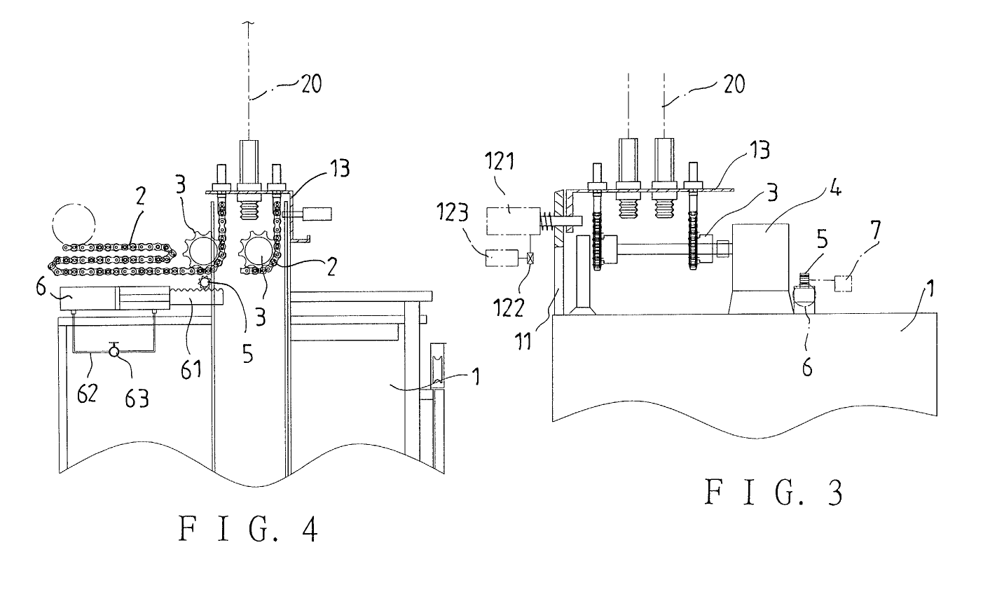

The chains 2 each passes under a respective one of the gear 3, and are wound around reels or other storing equipments from other end portions. The second connecting member 11 is fixedly disposed on the top of the car member 1, and the first connecting member 13 further has a lateral portion sticking down from the horizontal portion; the fall prevention device 12 has a securing oil hydraulic cylinder 121 having a piston rod 1211 capable of passing through holes of both the first and the second connecting members 13 and 11 to prevent one from moving relative to the other as shown in FIG. 3, i.e. the car member 1 is stopped from moving relative to the first connecting member 13 by means of the piston rod 1211 of the securing hydraulic cylinder 121 when the elevator is working properly; the fall prevention device 12 further having an oil container 123, and an oil drain valve 122 for controlling the movement ofthe piston rod 1211.

The positioning sensors 9 are disposed above 1 a respective one of elevator passage doors in the floors of the building. And, the car member 1 has an emitting device (not numbered) disposed above the door thereof and an emergency control button (not shown) disposed in the member 1.

When the car member 1 is forced to stop between two adjacent one of the floors of the building due to power failure or breakdown of the elevator, the passengers in the member 1 push the emergency button in the car 1 to activate the emergency power supply 8.

The oil drain valve 122 is opened for permitting oil to flow into the oil container 123 from the securing cylinder 121 so that the piston rod 1211 separates from the first and the second connecting members 13 and 11 for permitting the car member 1 to move relative to the first connecting member 11.

At the same time, the braking switch 7 is activated to free the main moving gear 5 from a locking position so that the same can turn. When turning, the main moving gear 5 makes the moving toothed bar 61 move along. Consequently, the gears 3 connected to the shafts of the reduction gear 4 are turned for permitting the car member 1 to move down to the nearest floor from between the two adjacent floors.

The governor valve 63 is connected to the oil return pipe 62, which is connected to the main body of the oil hydraulic cylinder 6, such that speed of the moving toothed bar 61 can be adjusted by means of the governor valve 63.

When the member 1 is moved down to the next floor after the emergency moving device is activated, the emitting device faces the positioning sensor 9 of that floor, and the positioning sensor 9 causes the braking switch 7 to stop the main moving gear 5 from turning. Thus, the passengers in the car member 1 can easily and safely get off same.

When the power failure or breakdown of the elevator is fixed, the gears 3 is turned in the opposite direction, and the chains 6 wound back around the reels for reducing the space between the car member 1 and the first connecting member 13 to a proper one. And, the piston rod 1211 passes through the holes of the connecting member 11 and 13 to prevent the car member from moving relative to the first connecting member 13.

From the above description, the emergency moving device of an elevator according to the present invention can be known to be able to lower the car member to a next floor exactly and without delay after a breakdown or power failure of the elevator such that the passengers can get off the elevator safely and easily without having to suffer from waiting a long time.

What is claimed is:

1. An emergency moving device of an elevator, comprising
a main moving gear disposed on a top of a car member of said elevator;
a reduction gear fixed on top of said car;
a plurality of gears; said reduction gear having shafts connected to said gears for imparting a turning movement to said gears on activation of said main moving gear connected thereto;
a plurality of chains passing under a respective one of said gears; said chains being connected to a bottom of a first connecting member fixedly connected to steel ropes of said elevator for permitting said gears to be driven by said main moving gear to make said elevator car move downwards relative to said first connecting member when an emergency power supply is controlled to activate a fall prevention member to free a second connecting member of a top of said car from said first connecting member, and to activate a braking switch of said main moving gear for permitting said main moving gear to turn in a breakdown of said elevator causing said car to stop between two adjacent one of floors of a building;
whereby said car can be moved downwards, and stop at a lower one of said adjacent floors.

2. The emergency moving device of an elevator as claimed in claim 1, wherein other end portions of said chains are wound around a storing equipment disposed in said elevator.

3. The emergency moving device of an elevator as claimed in claim 1, wherein said fall prevention member includes an oil hydraulic cylinder having a piston rod separably passing through holes of both said first and second connecting members to prevent same from moving relative to each other.

4. The emergency moving device of an elevator as claimed in claim 1, wherein said main moving gear engages a moving toothed bar; said toothed bar engaging said reduction gear for imparting a turning movement to said reduction gear on said activation of said main moving gear.

5. The emergency moving device of an elevator as claimed in claim 4, wherein said toothed bar is connected to a hydraulic cylinder; said cylinder including an oil return pipe, and a governor valve for adjusting a speeding of said toothed bar engaging said main moving gear.

6. An emergency moving device of an elevator as claimed in claim 1 further having a positioning sensor for making said fall prevention member move to a locking position preventing said car from moving down relative to said first connecting member and for making said braking switch stop said main moving gear from turning when said car is lowered to said lower floor.
